(19) United States
(12) Patent Application Publication
(10) Pub. No.: US 2026/0304182 A1
(43) Pub. Date: Oct. 1, 2026

(54) TECHNOLOGIES FOR MONITORING BEAM PREDICTION MODEL

(71) Applicant: Apple Inc., Cupertino, CA (US)

(72) Inventors: Konstantinos Sarrigeorgidis, Los Gatos, CA (US); Manasa Raghavan, Sunnyvale, CA (US); Rolando E. Bettancourt Ortega, Munich (DE); Jie Cui, San Jose, CA (US); Yang Tang, San Jose, CA (US); Dawei Zhang, Saratoga, CA (US); Xiang Chen, Palo Alto, CA (US); Qiming Li, Beijing (CN); Yuexia Song, Beijing (CN)

(21) Appl. No.: 19/283,067

(22) Filed: Jul. 28, 2025

(30) Foreign Application Priority Data
Mar. 28, 2025 (GR) 20250100248

(51) Int. Cl. H04W 24/10

(52) U.S. Cl. CPC H04W 24/10

(57) ABSTRACT

The present application relates to devices and components including apparatuses, systems, and methods for performance monitoring of a beam prediction model.

### CROSS-REFERENCE TO RELATED APPLICATION

This application claims priority to Greek application No. 20250100248, entitled “Technologies for Monitoring Beam Prediction Model,” filed on Mar. 28, 2025, which is herein incorporated by reference in its entirety for all purposes.

### TECHNICAL FIELD

This application relates generally to communication networks and, in particular, to technologies associated with monitoring a beam prediction model.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates an example of a beam prediction model, in accordance with some embodiments.

FIG. 3 illustrates an example of beam monitoring circuitry, in accordance with some embodiments.

FIG. 4 illustrates an example of UE-assisted performance monitoring of a beam prediction model, in accordance with some embodiments.

FIG. 5 illustrates an example of network-side performance monitoring of a UE-side beam prediction model, in accordance with some embodiments.

FIG. 6 illustrates an operational flow/algorithmic structure in accordance with some embodiments.

FIG. 7 illustrates another operational flow/algorithmic structure in accordance with some embodiments.

FIG. 8 illustrates a user equipment in accordance with some embodiments.

FIG. 9 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component or asset within a computing or network environment, or a physical or virtual component within, accessible by, or available to a device or component. Resources could include, but are not limited to, memory space/usage, processor/CPU time, processor/CPU usage, processor and accelerator loads, hardware time or usage, electrical power, input/output operations, ports or network sockets, channel/link allocations, throughput, or workload units. A “hardware resource” may refer to compute, storage, or networking resources provided by physical hardware elements. A “virtualized resource” may refer to compute, storage, or networking resources provided by virtualization infrastructure to an application, device, or system. The term “communication resource” may refer to resources that are accessible by, or available to, computer devices/systems for transferring information over a channel of a communication network. For example, communication resources may include, but are not limited to, time/frequency resources, code resources, modulation resources, etc. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

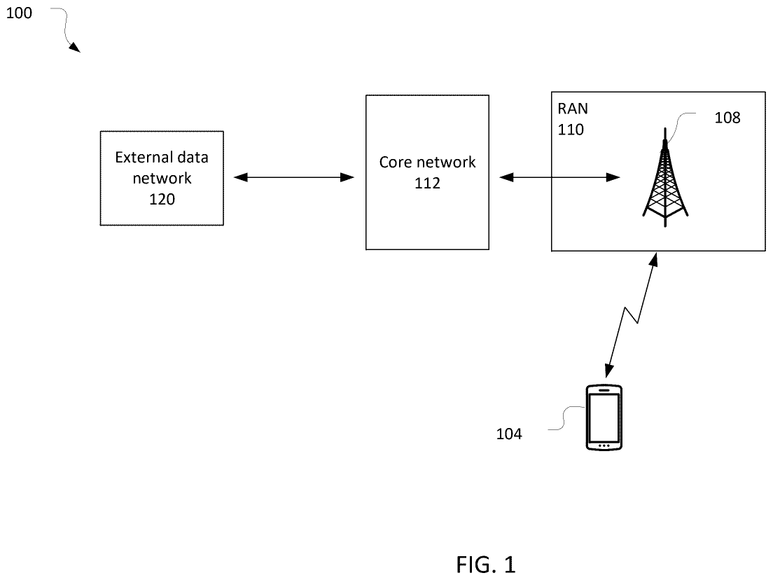

FIG. 1 illustrates a network environment 100 in accordance with some embodiments. The network environment 100 may include user equipment (UE) 104 communicatively coupled with base station 108 of a radio access network (RAN) 110. The UE 104 and the base station 108 may communicate over air interfaces compatible with 3GPP TSs, such as those that define a Fifth Generation (5G) new radio (NR) system or a later system (e.g., Sixth Generation (6G) system). The base station 108 may provide user plane (UP) and control plane (CP) protocol terminations toward the UE 104. In some embodiments, the base station 108 may include one or more transmission-reception points (TRPs) to transmit and/or receive signals to/from the UE 104.

The network environment 100 may further include a core network (CN) 112. For example, the CN 112 may comprise a 5th Generation Core network (5GC), a 6th Generation Core network (6GC), or later generation core network. The CN 112 may be coupled to the base station 108 via a fiber optic or wireless backhaul. The CN 112 may provide functions for the UE 104 via the base station 108. These functions may include managing subscriber profile information, subscriber location, authentication of services, or switching functions for voice and data sessions.

The network environment 100 may further include an external data network 120, which may be accessed by the UE 104 via the RAN 110.

The UE 104 and RAN 110 (e.g., base station 108) may perform beam management to select a transmit beam and/or a receive beam to use for a transmission (e.g., a downlink (DL) transmission from the base station 108 to the UE 104 or an uplink (UL) transmission from the UE 104 to the base station 108. In an example, the UE 104 may receive reference signals that are transmitted by the base station 108 with different transmit beams. The UE 104 may perform measurements on the respective reference signals and report one or more of the beams to the network based on the measurements (e.g., the UE 104 may report the one or more “best” beams that have the highest quality measurements). The reference signals may include, for example, synchronization signal blocks (SSBs, also referred to as a synchronization signal/physical broadcast channel (PBCH) blocks) and/or channel state information-reference signals (CSI-RSs).

The UE 104 may further perform receive beam sweeping (e.g., measuring a reference signal with different receive beams) to select a receive beam for a DL transmission. Additionally, the UE 104 may transmit an uplink reference signal (e.g., a sounding reference signal (SRS)) to the network. The network may perform measurements on the uplink reference signal for beam management.

In some embodiments, an artificial intelligence (AI)/machine learning (ML) model (e.g., referred to as a beam prediction model) may be used to predict one or more beams. The beam prediction model may be managed by the UE (e.g., implemented by the UE or another device in communication with the UE), the network, and/or another entity.

In an example, the beam prediction model may receive beam measurements for a first set of beams as an input and may output beam information for a second set of beams. The beam measurements may include, for example, a reference signal received power (RSRP), a reference signal received quality (RSRQ), and/or another suitable measurement.

The second set of beams may include additional beams not included in the first set of beams. The second set of beams may or may not be defined to include the first set of beams. Individual beams of the first set and/or second set may correspond to a transmit beam, a receive beam, and/or a pair of transmit beam and receive beam. In an example, the output beam information may include predicted beam measurements for the second set of beams (e.g., for the beams that are not included in the first set of beams). In another example, the output beam information may include a ranking of some or all of the second set of beams (which may be defined to include the first set of beams in this case). For example, the ranking may indicate the top K beams, where K is an integer of one or more. When the output beam information includes the ranked beams, the output beam information may or may not also include predicted beam measurements corresponding to the ranked beams.

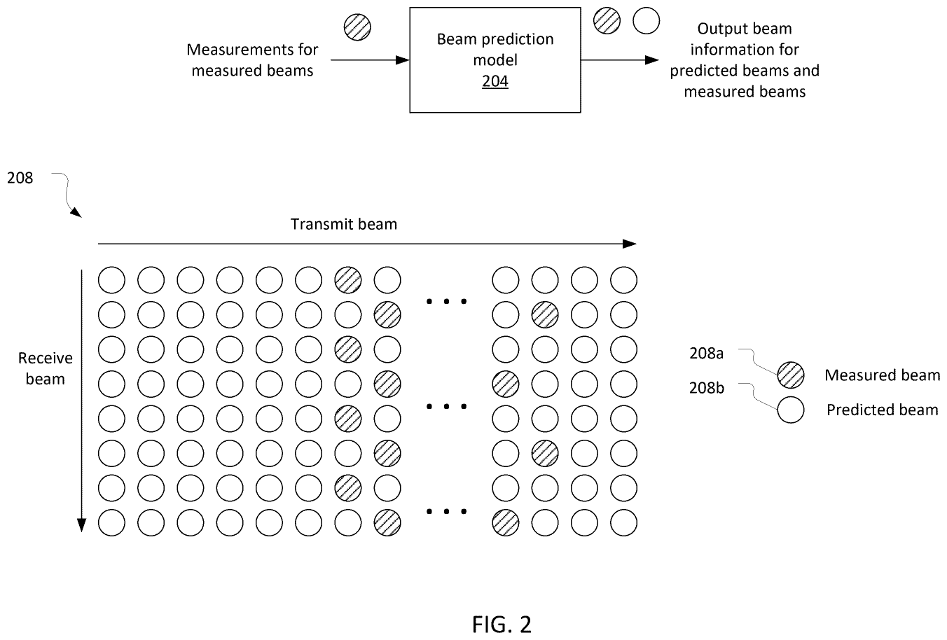

FIG. 2 illustrates an example of a beam prediction model 204 in accordance with some embodiments. The example of FIG. 2 is illustrated with respect to beam selection for a DL transmission, e.g., to select a transmit beam to be used by the base station and/or a receive beam to be used by the UE. For example, FIG. 2 illustrates a plurality of beams 208, with individual beams 208 associated with a transmit beam and a receive beam (which may collectively be referred to as a beam pair). The beams 208 may include a subset of beams 208a that are measured by the UE. The measurements on beams 208a may be provided as an input to the beam prediction model 204. The beam prediction model 204 may generate output beam information for the beams 208, including for beams 208b that are not included in the input. As discussed above, the output beam information may include predicted beam measurements and/or predicted beam rankings (e.g., a set of the best K predicted beams, which may be ranked in order of quality).

The UE and/or base station may monitor performance of the beam prediction model, e.g., based on one or more performance metrics (which may be referred to as key performance indicators (KPIs)). For example, the UE may perform additional measurements on one or more beams for monitoring the output of the beam prediction model. The additional measurements may be performed on respective monitoring resources that are configured for monitoring. The additional measurements may be on beams (e.g., beams 208b of beams 208 shown in FIG. 2) that correspond to predicted beams output by the beam prediction model and not provided as inputs to the model.

For a beam prediction model that outputs a beam ranking (e.g., the top K beams), existing techniques only determine whether a top measured beam is among the top K beams output by the beam prediction model. However, this may not provide an accurate representation of the performance of the beam prediction model.

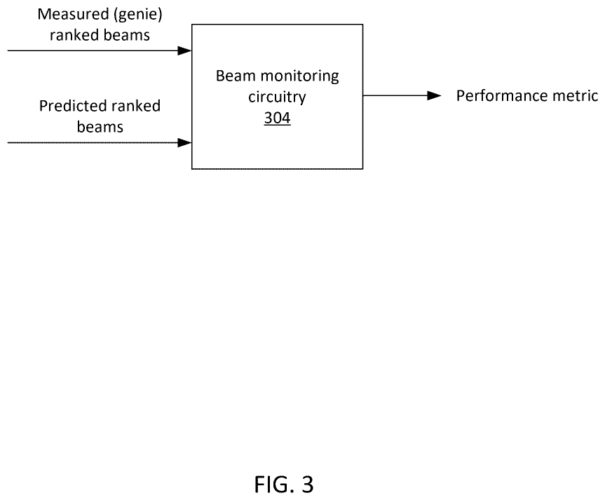

Embodiments herein provide mechanisms to evaluate performance of a beam prediction model that outputs a ranking of the top K beams. FIG. 3 illustrates an example of a beam monitoring circuitry 304, in accordance with some embodiments. The beam monitoring circuitry 304 may be implemented by a UE (e.g., UE 104), a base station (e.g., base station 108), a device of a core network (e.g., core network 112), or components thereof (e.g., processor circuitry, such as baseband processor circuitry).

The beam monitoring circuitry 304 may receive as inputs the set of predicted ranked beams generated by the beam prediction model and a set of measured ranked beams (also referred to as genie ranked beams). The UE may generate the set of measured ranked beams based on respective measurements on the beams. For example, the UE may measure additional beams (e.g., all of the candidate beams, such as of a codebook) for purposes of monitoring the performance of the beam prediction model. The monitoring measurements may be performed less frequently than the measurements used for beam prediction, thus substantially maintaining the overhead savings provided by the beam prediction model.

The beam monitoring circuitry 304 may generate one or more performance metrics (e.g., KPIs) based on the predicted ranked beams and the measured ranked beams. In some embodiments, the performance metric may be based on all of the beams in the set of predicted ranked beams (e.g., the top-K beams) or a subset of beams in the set of predicted ranked beams (e.g., a subset of one or more beams or a subset of two or more beams). As discussed above, the set of predicted ranked beams may be a subset of all the candidate beams (e.g., the top-K beams), so a subset of the set of predicted ranked beams may further limit the beams that are used to calculate the performance metric.

Some example metrics that may be used for the one or more performance metrics include a Spearman correlation, a Kendall Correlation, a normalized discounted cumulative gain (nDCG), and/or a rank-biased overlap (RBO). Other metrics that reflect the quality of the set of predicted ranked beams (e.g., based on comparison with the genie ranked beams) may additionally or alternatively be used in accordance with embodiments herein.

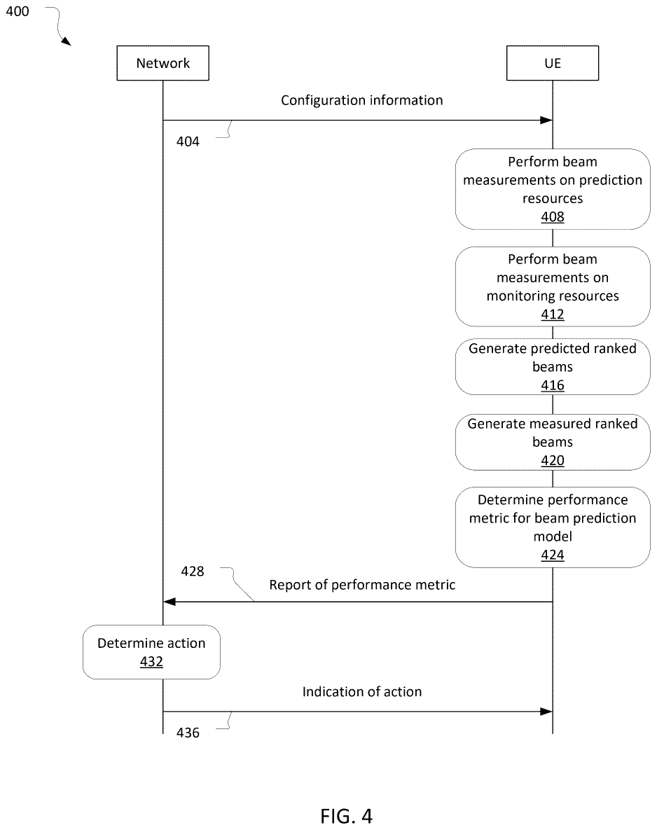

As discussed above, the one or more performance metrics may be calculated by the UE, the network (e.g., base station and/or core network), and/or another device. FIG. 4 illustrates an example procedure 400 for UE-assisted performance monitoring, in accordance with some embodiments. In the procedure 400, the UE may calculate the one or more performance metrics and report the one or more performance metrics to the network. Aspects of the procedure 400 may be performed by the UE (e.g., UE 104), the network (e.g., base station 108), and/or components thereof (e.g., processor circuitry).

At 404 of the procedure 400, the UE may receive configuration information from the network to configure performance monitoring of a beam prediction model. For example, the configuration information may be received via radio resource control (RRC) signaling.

In an example, the configuration information may indicate monitoring resources used for performance monitoring. The monitoring resources may correspond to resources in which the UE is to perform additional beam measurements (e.g., referred to as monitoring measurements) to generate the set of genie ranked beams.

In some embodiments, the monitoring resources may be dedicated resources used for monitoring the CSI prediction model. For example, the UE may receive a separate configuration of resources (e.g., referred to as prediction resources) on which the UE is to perform beam measurements that are used by the beam prediction model to generate the set of predicted ranked beams. The prediction resources may be configured in the same message (e.g., RRC message) that configures the monitoring resources and/or a different message (e.g., another RRC message).

In some embodiments, the configuration information may indicate a reporting configuration for the UE to report the performance monitoring results. For example, the reporting configuration may indicate a reporting resource (e.g., a time-frequency resource) in which the UE is to transmit the report. The resource may be periodic, semi-persistent, or aperiodic (e.g., triggered by request from the network, such as in a downlink control information (DCI)). In some embodiments, the report may be triggered based on the performance metric of the beam prediction model exceeding a threshold, which may be configured by the network (e.g., in the configuration information). The configuration information may indicate reporting occasions in which the UE may transmit a report if triggered and/or other timing information (e.g., a timing offset from a reference resource, such as from a slot associated with the monitoring resources and/or prediction resources) that may be used by the UE to determine a time resource in which to transmit the report.

At 408 of the procedure 400, the UE may perform one or more beam measurements on the configured prediction resources. At 412 of the procedure 400, the UE may perform one or more beam measurements on the configured monitoring resources.

At 416 of the procedure 400, the UE may generate a set of predicted ranked beams (e.g., top K beams) based on the one or more beam measurements on the prediction resources. The predicted ranked beams may be generated using the beam prediction model (e.g., an AI/ML model).

At 420 of the procedure 400, the UE may determine a set of measured ranked beams (also referred to as genie ranked beams). The set of measured ranked beams may be determined based on the beam measurements on the monitoring resources and/or the prediction resources (e.g., on both sets of resources to include all candidate beams).

At 424 of the procedure 400, the UE may determine (e.g., calculate) a performance metric for the beam prediction model. The performance metric may be determined based on the predicted ranked beams and the measured ranked beams, as described herein.

At 428 of the procedure 400, the UE may generate a report to indicate the performance metric and transmit the report to the network. In some embodiments, the report may indicate a value (e.g., a quantized value) of the performance metric. For example, the report may include a field with multiple bits to indicate the value of the performance metric. In other embodiments, the report may include a single bit to indicate whether the performance metric has exceeded a threshold. For example, the report may include a 1-bit flag in the header of the report. In some embodiments, the threshold may be configured by the network.

In some embodiments, the report at 428 may correspond to a beam management report that also includes beam management feedback. The beam management feedback may include the set of predicted ranked beams and/or the set of measured ranked beams.

In some embodiments, the UE may transmit the report to the network based on a triggering event. For example, the triggering event may include that the performance metric has exceeded a threshold (e.g., the same threshold that is used to indicate the value of the performance metric or a different threshold), a request received by the UE from the network, and/or another event.

At 432 of the procedure 400, the network may determine an action to take based on the report. For example, the network may determine to deactivate the beam prediction model (e.g., and fallback to legacy beam management), re-train the beam prediction model, and/or switch to another beam prediction model. In another example, the network may determine to adjust one or more thresholds used for the monitoring report (e.g., the threshold that may be used to trigger transmission of the report and/or the indication in the report that the performance metric has exceeded the threshold).

At 436 of the procedure 400, the network may transmit an indication of the action to the UE. For example, the network may transmit a message (e.g., a MAC CE) with a 1-bit flag to deactivate or activate a beam prediction model. In another example, the network may transmit a RRC reconfiguration message to the UE that indicates a different beam management mode (e.g., legacy beam management) and/or indicates one or more different thresholds associated with performance monitoring of the beam prediction model.

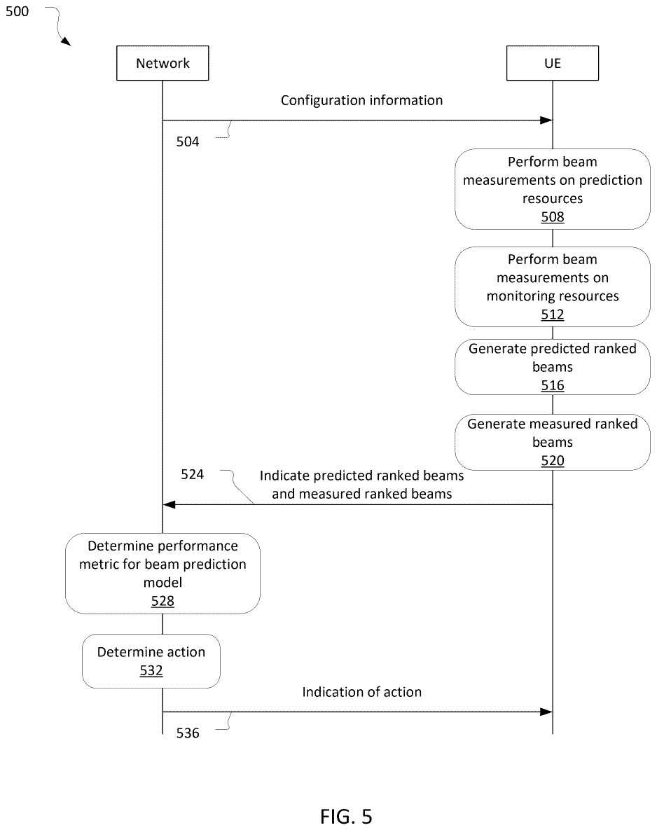

FIG. 5 illustrates an example procedure 500 for network-side performance monitoring of a beam prediction model in accordance with some embodiments. Aspects of the procedure 500 may be performed by the UE (e.g., UE 104), the network (e.g., base station 108), or components thereof (e.g., processor circuitry).

Operations 504, 508, 512, 516, and 520 of procedure 500 may be similar to respective operations 404, 408, 412, 416, and 420 of procedure 400 described above.

At 524 of procedure 500, the UE may transmit the set of predicted ranked beams (determined by the beam prediction model) and the set of measured ranked beams (determined based on associated beam measurements) to the network. At 528, the network may determine the beam performance metric for the beam prediction model.

At 532, the network may determine an action to take based on the performance metric, e.g., similar to operation 432 of procedure 400. At 536, the network may transmit an indication of the action to the UE, e.g., similar to operation 436 of procedure 400.

Some examples of calculating the performance metric based on a set of predicted ranked beams and a set of measurement ranked beams are provided below.

In an example, the performance metric may include a Spearman correlation. The Spearman correlation may be based on the rankings of the respective beams in the set of the predicted ranked beams compared with the corresponding rankings of the same beam (e.g., with the same beam index) in the set of measurement ranked beams. For example, the Spearman correlation, ρ, may be given by:

$$ρ = 1 - 6 \frac{\sum {d}_{i}^{2}}{n ( {n}^{2} - 1 )}$$

where n is the number of beams (e.g., beam indexes corresponding to a predicted beam and an associated measured beam) used to compute the metric, and dᵢ is a difference between the rank of the measured beam and predicted beam with the same beam index.

The Spearman correlation may give a value between −1 and 1, where a value of 1 indicates a perfect positive correlation (the predicted ranks exactly match the measured ranks), a value of 0 indicates no correlation, and a value of −1 indicates a perfect negative correlation (the predicted ranks are the reverse of the measured ranks).

Table 1 below shows an example dataset, including beam index (assigned in order of measured rank), the associated measured rank and predicted rank, and the corresponding values of dᵢ and

$${d}_{i}^{2} :$$

TABLE 1

| Beam | Measured | Predicted | | |
|---|---|---|---|---|
| Index | Rank | Rank | dᵢ | dᵢ² |
| 1 | 1 | 2 | −1 | 1 |
| 2 | 2 | 1 | 1 | 1 |
| 3 | 3 | 4 | −1 | 1 |
| 4 | 4 | 3 | 1 | 1 |
| 5 | 5 | 5 | 0 | 0 |

In this example, the Spearman correlation, ρ, is:

$$ρ = 1 - \frac{6 \cdot 4}{5 ( {5}^{2} - 1 )} = 1 - 0.2 = 0.8 .$$

In some instances, the set of top-K predicted ranked beams may include a predicted beam that is not among the top-K measured ranked beams. In this situation, the Spearman correlation may still be calculated based on a difference between the ranking of the predicted beam in the set of predicted ranked beams compared with a corresponding measured beam (e.g., with a ranking greater than K). Alternatively, a different value (e.g., a predefined maximum value or other penalty value) may be used for dᵢ in this situation.

In another example, the performance metric may include a Kendall correlation (also referred to as a Kendall's Tau). For example, pairs of different beam indexes (e.g., all possible pairs of beam indexes that are included in the sets of predicted and/or measured ranked beams) may be identified. The individual pairs may be designated as concordant pairs or discordant pairs. A pair of beam indexes may be concordant if both the set of predicted ranked beams and the set of measured ranked beams have the same beam index of the pair ranked higher (e.g., in a pair with a first beam index and a second beam index, the predicted ranked beams and the measured ranked beams both have the first beam index ranked higher than the second beam index). In contrast, a pair of beam indexes may be discordant if the set of predicted ranked beams and the set of measured ranked beams disagree on the beam index of the pair that is ranked higher (e.g., in a pair with a first beam index and a second beam index, the predicted ranked beams have the second beam index ranked higher than the first beam index while the measured ranked beams have the first beam index ranked higher than the second beam index). If there are any ties in the set of measured ranked beams or the set of predicted ranked beams, those may be handled separately in the calculation.

The Kendall correlation, t, may be calculated as:

$$τ = \frac{C - D}{\sqrt{( {n}_{0} - {T}_{m e a s u r e d} ) ( {n}_{0} - {T}_{predicted} )}}$$

where C is the number of concordant pairs, D is the number if discordant pairs, n₀ is the number of pairs

$$( e . g . , {n}_{0} = \frac{n ( n - 1 )}{2}$$

with n equal to the number of beam indexes per set), T_{measured} is the number of ties in the set of measured ranked beams, and T_{predicted} is the number of ties in the set of predicted ranked beams. If there are no ties, the Kendall correlation may be simplified to:

$$τ = \frac{C - D}{{n}_{0}}$$

As with the Spearman correlation, the Kendall correlation may give a value between −1 and 1, where a value of 1 indicates a perfect positive correlation (the predicted ranks exactly match the measured ranks), a value of 0 indicates no correlation, and a value of −1 indicates a perfect negative correlation (the predicted ranks are the reverse of the measured ranks).

Table 2 illustrates an example dataset for purposes of illustrating an example calculation of the Kendall correlation. The dataset of Table 2 corresponds to the dataset of Table 1 above.

TABLE 2

| Beam | Measured | Predicted |
|---|---|---|
| Index | Rank | Rank |
| 1 | 1 | 2 |
| 2 | 2 | 1 |
| 3 | 3 | 4 |
| 4 | 4 | 3 |
| 5 | 5 | 5 |

Table 3 illustrates pairs of beam indexes for the dataset and corresponding designation as a concordant or discordant pair. The columns of measured order and predicted order indicate the corresponding ranking of the two beam indexes in the respective set and which of the two rankings has a lower value (ranked better).

TABLE 3

| Pair (i, j) | Measured Order | Predicted Order | Concordant/Discordant |
|---|---|---|---|
| (1, 2) | 1 < 2 | 2 > 1 | Discordant |
| (1, 3) | 1 < 3 | 2 < 4 | Concordant |
| (1, 4) | 1 < 4 | 2 < 3 | Concordant |
| (1, 5) | 1 < 5 | 2 < 5 | Concordant |
| (2, 3) | 2 < 3 | 1 < 4 | Concordant |
| (2, 4) | 2 < 4 | 1 < 3 | Concordant |
| (2, 5) | 2 < 5 | 1 < 5 | Concordant |
| (3, 4) | 3 < 4 | 4 > 3 | Discordant |
| (3, 5) | 3 < 5 | 4 < 5 | Concordant |
| (4, 5) | 4 < 5 | 3 < 5 | Concordant |

In this example, there are eight concordant pairs (C=8) and two discordant pairs (D=2), the total number of pairs (n₀) is 10, and there are no ties. Accordingly, the Kendall correlation may be calculated as:

$$τ = \frac{C - D}{{n}_{0}} = \frac{8 - 2}{10} = 0.6$$

In another example, the performance metric may include an nDCG. The nDCG may give greater weight to better-ranked beams in the ranking order of the predicted ranked beams and/or the measured ranked beams.

In an example, the nDCG may correspond to a discounted cumulative gain (DCG) divided by an ideal DCG (IDCG). For example, the nDCG at depth k (e.g., for the top k beams of the set of predicted ranked beams) may be given by:

$$nDCG @ k = \frac{DCG @ k}{IDCG @ k}$$

The DCG at depth k may be calculated according to:

$$DCG @ k = {\sum }_{i = 1}^{k} \frac{r e {l}_{i}}{{log}_{2} ( i + 1 )}$$

where i is the rank position in the set of beams, and relᵢ is the relevance score of the beam at rank position i in the set of predicted ranked beams.

The IDCG may be calculated according to:

$$IDCG @ k = {\sum }_{i = 1}^{k} \frac{{rel}_{i}^{i d e a l}}{{log}_{2} ( i + 1 )}$$

where

$${rel}_{i}^{ideal}$$

is the relevance score ordered based on the ranking of the set of measured ranked beams. The normalization based on the IDCG may provide a value of the nDCG in a range from 0 to 1.

In some embodiments, the nDCG may be computed based on all of the beams of the set of predicted ranked beams (e.g., depth k equal to the K beams of the set of predicted ranked beams). Accordingly, all of the ranked beams may provide a contribution to the nDCG. In other embodiments, the nDCG may be computed based on a subset of the beams of the set of predicted ranked beams (e.g., depth k less than the K beams of the set of predicted ranked beams).

Table 4 illustrates an example of a dataset (e.g., the same dataset of Table 1 and Table 2) and corresponding relevance score. In this example, the relevance score may be determined based on the rankings of the measured ranked beams (e.g., with better ranked beams having greater relevance scores).

TABLE 4

| | Measured | Predicted | Relevance |
|---|---|---|---|
| Beam Index | Rank | Rank | Score |
| 1 | 1 | 2 | 5 |
| 2 | 2 | 1 | 4 |
| 3 | 3 | 4 | 3 |
| 4 | 4 | 3 | 2 |
| 5 | 5 | 5 | 1 |

With this example dataset, the DCG with depth 5 (e.g., based on the ranking order of the predicted ranked beams and associated relevance scores) may be:

$$DCG @ 5 = \frac{4}{{log}_{2} ( 1 + 1 )} + \frac{5}{{log}_{2} ( 2 + 1 )} + \frac{2}{{log}_{2} ( 3 + 1 )} + \frac{3}{{log}_{2} ( 4 + 1 )} + \frac{1}{{log}_{2} ( 5 + 1 )}$$

$$DCG @ 5 \approx 4 + 3.154 + 1 + 1.292 + 0.387 = 9.833$$

The IDCG with depth 5 may be:

$$IDCG @ 5 = \frac{4}{{log}_{2} ( 1 + 1 )} + \frac{5}{{log}_{2} ( 2 + 1 )} + \frac{2}{{log}_{2} ( 3 + 1 )} + \frac{3}{{log}_{2} ( 4 + 1 )} + \frac{1}{{log}_{2} ( 5 + 1 )}$$

$$IDCG @ 5 \approx 5 + 2.524 + 1.5 + 0.862 + 0.387 = 10.287$$

Accordingly, the nDCG may be 9.833/10.287=0.956.

In another example, the nDCG may be calculated based further on the value of beam measurements (e.g., RSRP) of the respective measured beams. For example, Table 5 illustrates a dataset including beam IDs, associated RSRP in decibel-milliwatts (dBm), corresponding gain in milliwatts (mW). Table 5 further indicates example rankings for the top-5 beams (e.g., K=5) in the set of measured ranked beams and the set of predicted ranked beams.

TABLE 5

| | RSRP | Gain | Measured | Predicted |
|---|---|---|---|---|
| Beam ID | (dBm) | (mW) | Rank | Rank |
| A | −70 | 1 × 10⁻⁷ | 1 | 1 |
| B | −75 | 3.16 × 10⁻⁸ | 2 | 3 |
| C | −80 | 1 × 10⁻⁸ | 3 | 4 |
| D | −85 | 3.16 × 10⁻⁹ | 4 | 5 |
| E | −90 | 1 × 10⁻⁹ | 5 | |
| X | −95 | 3.16 × 10⁻¹⁰ | | 2 |

As shown in Table 5, the set of predicted ranked beams includes beam X with the second best ranking, while beam X is not among the top-5 beams in the set of measured ranked beams. The RSRP may be converted to gain for purposes of calculating the nDCG since nDCG may require a linear scale.

In an example, the nDCG may be calculated using the associated gain as the relevance score. For example, the DCG and IDCG may be determined according to:

$$D C G = {\sum }_{i = 1}^{k} \frac{{Gain}_{i}}{{log}_{2} ( i + 1 )}$$

where Gain; is the gain for the beam with ranking i in the respective set of ranked beams (e.g., the predicted ranked beams for the DCG or the measured ranked beams for the IDCG).

Table 6 illustrates example calculations to determine the DCG based on the predicted ranked beams. For example, Table 6 illustrates the discount that is applied to the gain at each ranking position and the corresponding discounted gain.

TABLE 6

| Ranking | Beam | Gain | Discount | | Discounted |
|---|---|---|---|---|---|
| position | ID | (mW) | (log₂(i + 1)) | | Gain |
| 1 | A | 1 × 10⁻⁷ | 1 | | 1 |
| 2 | X | 3.16 × 10⁻¹⁰ | log₂3 | (1.585) | 2 × 10⁻¹⁰ |
| 3 | B | 3.16 × 10⁻⁸ | log₂4 | (2) | 1.58 × 10⁻⁸ |
| 4 | C | 1 × 10⁻⁸ | log₂5 | (2.322) | 4.33 × 10⁻⁹ |
| 5 | D | 3.16 × 10⁻⁹ | log₂6 | (2.585) | 1.22 × 10⁻⁹ |

The discounted gains for all the ranking positions are added to get the DCG for the predicted ranked beams. Accordingly, for the dataset of Table 5, the DCG for the predicted ranked beams is about 1.215×10⁻⁷.

The IDCG for the dataset of Table 5 is about 1.267×⁻⁷. Accordingly, the nDCG (DCG/IDCG) is 1.215×10⁻⁷/1.267×⁻⁷, which is about 0.959. Therefore, the nDCG for the dataset is less than 1 since the beam with the second ranking in the set of predicted ranked beams (beam X) has a significantly lower RSRP than the second ranked beam (beam B) of the set of measured ranked beams. If beam X were ranked lower in the set of predicted ranked beams, the nDCG would improve.

The nDCG is one example of a performance metric that uses different weights for different beams of the set of predicted ranked beams (e.g., based on the associated rankings of the predicted ranked beams and/or measured ranked beams). Different weights and/or weighting techniques may be used in accordance with various embodiments herein.

In another example, the performance metric may include an RBO. The RBO may provide a metric based on the comparison of two ranked lists, and may be particularly suited to partial and/or top-heavy rankings. Accordingly, RBO may be useful for evaluating beam prediction accuracy, in which the top-K rankings may be prioritized.

As with the nDCG, the RBO may be calculated with a maximum depth k. The maximum depth k may be equal to the number of beams in the set of predicted ranked beams or a subset of less than all of the beams in the set of predicted ranked beams.

The RBO may be calculated according to:

$$R B O = ( 1 - p ) {\sum }_{d = 1}^{k} {p}^{d - 1} {A}_{d}$$

where p is a persistence parameter between 0 and 1 (e.g., 0<p<1), which controls the emphasis on top-ranked beams (with lower p values giving more weight to top ranks); k is the depth of the comparison (e.g., corresponding to the maximum rank considered in the metric); and A_{d} is the agreement at depth d, which may be defined as the proportion of beams shared in the top-d lists of the two rankings.

In embodiments, the maximum depth k and/or persistence parameter p may be configured. For example, the network may transmit configuration information to the UE to indicate the maximum depth k and/or persistence parameter p to use for calculating the RBO.

Table 7 illustrates an example dataset, indicating the respective rankings of beams in the set of measured ranked beams and the set of predicted ranked beams.

TABLE 7

| Beam Ranking | Measured | Predicted |
|---|---|---|
| 1 | Beam A | Beam B |
| 2 | Beam B | Beam A |
| 3 | Beam C | Beam D |
| 4 | Beam D | Beam C |
| 5 | Beam E | Beam E |

To compute the RBO, the agreement A_{d}, at each depth (up to depth k) may be determined. The agreement A_{d} may be determined according to:

$${A}_{d} = \frac{number of overlapping beams in top d}{d}$$

Accordingly, for a given value of d, if all of the top d beams in the predicted ranked beams are also in the top d beams of the measured ranked beams (regardless of order), the value of A_{d} is 1. The values of Ad for the dataset of Table 7 at depth 1 through 5 are shown in Table 8.

TABLE 8

| Depth | Top d | Top d | Over- | | p^{d-1} for | p^{d-1} for |
|---|---|---|---|---|---|---|
| (d) | (measured) | (predicted) | lap | A_{d} | p = 0.9 | p = 0.5 |
| 1 | A | B | 0 | 0.0 | 1 | 1 |
| 2 | A, B | B, A | 2 | 1.0 | 0.9 | 0.5 |
| 3 | A, B, C | B, A, D | 2 | 0.67 | 0.81 | 0.25 |
| 4 | A, B, C, D | B, A, D, C | 4 | 1.0 | 0.729 | 0.125 |
| 5 | A, B, C, D, E | B, A, D, C, E | 5 | 1.0 | 0.6561 | 0.0625 |

Using the RBO equation above with a persistence parameter p of 0.9 results in an RBO of (1−0.9)×2.828=0.2828. The ideal RBO for depth 5 with p of 0.9 is (1−0.9)×(1+0.9+0.81+0.729+0.6561)=0.4095. Accordingly, the RBO for depth 5 with p of 0.9 may be normalized (to provide a value between 0 and 1) to 0.2828/0.4095=0.691.

If a persistence parameter of 0.5 is used with depth 5, the RBO of the dataset of Table 7 is (1−0.5)×0.855=0.4275. The ideal RBO for depth 5 with p of 0.5 is (1−0.5)×(1+0.5+0.25+0.125+0.0625)=0.96875. Accordingly, the normalized RBO for depth 5 with p of 0.5 may be 0.4275/0.96875=0.441.

The RBO for the dataset of Table 7 demonstrates a significant effect from the first ranked predicted beam (beam B) being different than the first ranked measured beam (beam A). This difference has a more pronounced effect on the RBO with p of 0.5 than with p of 0.9.

As discussed above, the UE may receive configuration information from the network to configure the maximum depth and/or weighting factor (e.g., persistence p) to be used for determining that performance metric. In some embodiments, the network may configure the depth and/or weighting factor based on one or more characteristics of the cell and/or beam management. In an example, the network may configure a smaller depth and/or stronger weighting factor (e.g., a lower persistence p to weight more heavily toward the top rankings) for beam selection at high frequency, such as frequency range 2 (FR2, e.g., millimeter wave (mmWave)). In another example, the network may configure a larger depth and/or weaker weighting factor for cell-wide beam management.

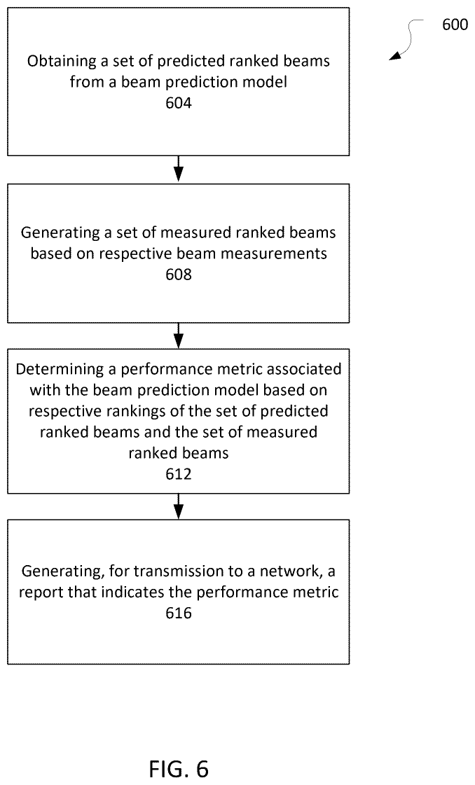

FIG. 6 illustrates an operational flow/algorithmic structure 600 in accordance with some embodiments. In some embodiments, the operational flow/algorithmic structure 600 may be implemented by a UE such as, for example, UE 104, UE 800, or components thereof, for example, processors 804A.

The operational flow/algorithmic structure 600 may include, at 604, obtaining a set of predicted ranked beams from a beam prediction model. The beam prediction model may be an AI/ML model. In an example, the beam prediction model may be a UE-side model (e.g., managed and/or implemented by the UE).

The operational flow/algorithmic structure 600 may further include, at 608, generating a set of measured ranked beams based on respective beam measurements. In an example, the UE may receive configuration information to indicate a set of monitoring resources and may perform the beam measurements on the monitoring resources.

The operational flow/algorithmic structure 600 may further include, at 612, determining a performance metric associated with the beam prediction model based on respective rankings of the set of predicted ranked beams and the set of measured ranked beams. In an example, the performance metric may be weighted toward beams of the set or predicted ranked beams or the set of measured ranked beams with higher rankings. In another example, the performance metric may be based on a subset of predicted ranked beams that have a highest ranking among the set of predicted ranked beams. In some embodiments, the UE may receive configuration information to indicate a weighting factor and/or a number of beams to include in the subset for the performance metric.

In some embodiments, the performance metric may be further based on measurement values (e.g., RSRP) for the beams of the predicted ranked beams and/or measured ranked beams. For example, the performance metric may include an nDCG based on the measurement values.

In some embodiments, the performance metric may include a Spearman correlation, a Kendall correlation, an nDCG, or an RBO.

The operational flow/algorithmic structure 600 may further include, at 616, generating, for transmission to a network, a report that indicates the performance metric. In some embodiments, the UE may receive a message from the network to indicate an action to take (e.g., based on the performance metric). For example, the action may include to deactivate the beam prediction model, fallback to legacy beam management, re-train the beam prediction model, and/or switch to another beam prediction model. The message may include, for example, an RRC message, a MAC-CE, and/or a DCI.

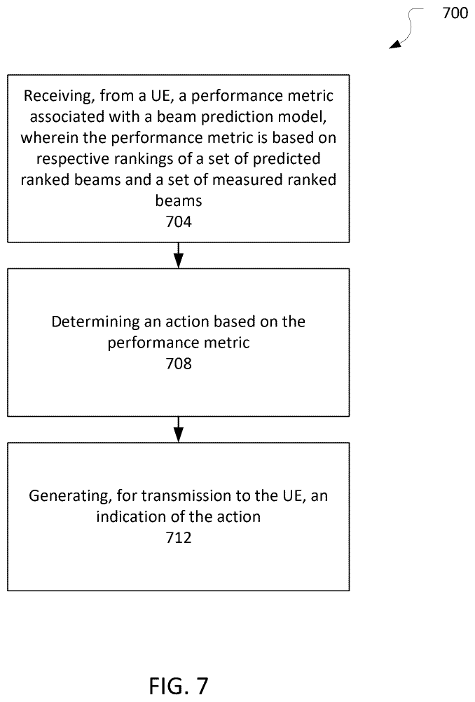

FIG. 7 illustrates another operational flow/algorithmic structure 700 in accordance with some embodiments. In some embodiments, the operational flow/algorithmic structure 700 may be implemented by a network device, such as a base station (e.g., base station 108), network device 900, or components thereof, for example, processors 904A.

The operational flow/algorithmic structure 700 may include, at 704, receiving, from a UE, a performance metric associated with a beam prediction model, wherein the performance metric is based on respective rankings of a set of predicted ranked beams and a set of measured ranked beams. In an example, the performance metric may be weighted toward beams of the set or predicted ranked beams or the set of measured ranked beams with higher rankings. In another example, the performance metric may be based on a subset of predicted ranked beams that have a highest ranking among the set of predicted ranked beams.

In some embodiments, the network may transmit configuration information to the UE to indicate a weighting factor and/or a number of beams to include in the subset for the performance metric.

In some embodiments, the performance metric may be further based on measurement values (e.g., RSRP) for the beams of the predicted ranked beams and/or measured ranked beams. For example, the performance metric may include an nDCG based on the measurement values.

In some embodiments, the performance metric may include a Spearman correlation, a Kendall correlation, an nDCG, or an RBO.

The operational flow/algorithmic structure 700 may further include, at 708, determining an action based on the performance metric. For example, the action may include to deactivate the beam prediction model, fallback to legacy beam management, re-train the beam prediction model, and/or switch to another beam prediction model.

The operational flow/algorithmic structure 700 may further include, at 712, generating, for transmission to the UE, an indication of the action. For example, the indication of the action may be included in an RRC message, a MAC-CE, and/or a DCI.

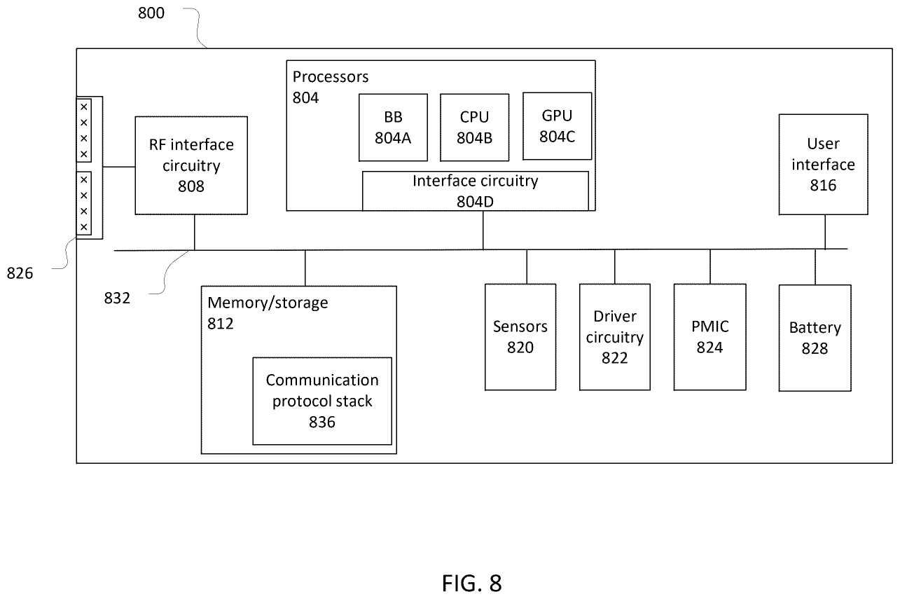

FIG. 8 illustrates a UE 800 in accordance with some embodiments. The UE 800 may be similar to and substantially interchangeable with UE 104.

The UE 800 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 800 may include processors 804, RF interface circuitry 808, memory/storage 812, user interface 816, sensors 820, driver circuitry 822, power management integrated circuit (PMIC) 824, antenna 826, and battery 828. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 832, which may represent any type of interface, input/output, bus (local, system, or expansion), transmission line, trace, or optical connection that allows various circuit components (on common or different chips or chipsets) to interact with one another.

The processors 804 may include processor circuitry such as, for example, baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage 812 to cause the UE 800 to perform operations as described herein (e.g., operations associated with performance monitoring of a beam prediction model). The processors 804 may also include interface circuitry 804D to enable communication by, for example, communicatively coupling the processor circuitry with one or more other components of the UE 800.

In some embodiments, the baseband processor 804A may access a communication protocol stack 836 in the memory/storage 812 to communicate over a 3GPP compatible network. In general, the baseband processor 804A may access the communication protocol stack 836 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 808.

The baseband processor 804A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 812 may include one or more non-transitory, computer-readable media that includes instructions (for example, communication protocol stack 836) that may be executed by one or more of the processors 804 to cause the UE 800 to perform operations as described herein (e.g., operations associated with performance monitoring of a beam prediction model).

The memory/storage 812 includes any type of volatile or non-volatile memory that may be distributed throughout the UE 800. In some embodiments, some of the memory/storage 812 may be located on the processors 804 themselves (for example, memory/storage 812 may be part of a chipset that corresponds to the baseband processor 804A), while other memory/storage 812 is external to the processors 804 but accessible thereto via a memory interface. The memory/storage 812 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 808 may include transceiver circuitry and a radio frequency front module (RFEM) that allows the UE 800 to communicate with other devices over a radio access network. The RF interface circuitry 808 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 826 and proceed to filter and amplify (with a low-noise amplifier) the signal. The signal may be provided to a receiver of the transceiver that down-converts the RF signal into a baseband signal that is provided to the baseband processor of the processors 804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 826.

In various embodiments, the RF interface circuitry 808 may be configured to transmit/receive signals in a manner compatible with NR access technologies.

The antenna 826 may include antenna elements to convert electrical signals into radio waves to travel through the air and to convert received radio waves into electrical signals. The antenna elements may be arranged into one or more antenna panels. The antenna 826 may have antenna panels that are omnidirectional, directional, or a combination thereof to enable beamforming and multiple input, multiple output communications. The antenna 826 may include microstrip antennas, printed antennas fabricated on the surface of one or more printed circuit boards, patch antennas, or phased array antennas. The antenna 826 may have one or more panels designed for specific frequency bands including bands in FR1 or FR2.

The user interface 816 includes various input/output (I/O) devices designed to enable user interaction with the UE 800. The user interface 816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 800.

The sensors 820 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 822 may include software and hardware elements that operate to control particular devices that are embedded in the UE 800, attached to the UE 800, or otherwise communicatively coupled with the UE 800. The driver circuitry 822 may include individual drivers allowing other components to interact with or control various input/output (I/O) devices that may be present within, or connected to, the UE 800. For example, driver circuitry 822 may include a display driver to control and allow access to a display device, a touchscreen driver to control and allow access to a touchscreen interface, sensor drivers to obtain sensor readings of sensors 820 and control and allow access to sensors 820, drivers to obtain actuator positions of electro-mechanic components or control and allow access to the electro-mechanic components, a camera driver to control and allow access to an embedded image capture device, audio drivers to control and allow access to one or more audio devices.

The PMIC 824 may manage power provided to various components of the UE 800. In particular, with respect to the processors 804, the PMIC 824 may control power-source selection, voltage scaling, battery charging, or DC-to-DC conversion.

A battery 828 may power the UE 800, although in some examples the UE 800 may be mounted deployed in a fixed location and may have a power supply coupled to an electrical grid. The battery 828 may be a lithium ion battery, a metal-air battery, such as a zinc-air battery, an aluminum-air battery, a lithium-air battery, and the like. In some implementations, such as in vehicle-based applications, the battery 828 may be a typical lead-acid automotive battery.

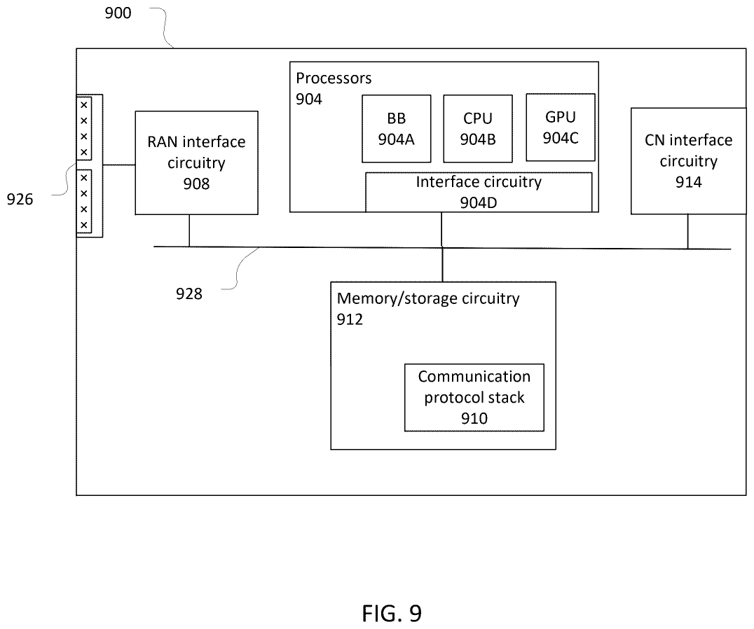

FIG. 9 illustrates a network device 900 in accordance with some embodiments. The network device 900 may be similar to, and substantially interchangeable with, the base station 108 and/or a component of the CN 112.

The network device 900 may include processors 904, RF interface circuitry 908 (if implemented as a base station), core network (CN) interface circuitry 914, memory/storage circuitry 912, and antenna structure 926.

The components of the network device 900 may be coupled with various other components over one or more interconnects 928.

The processors 904, RF interface circuitry 908, memory/storage circuitry 912 (including communication protocol stack 910), antenna structure 926, and interconnects 928 may be similar to like-named elements shown and described with respect to FIG. 8.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage circuitry 912 to cause the network device 900 to perform operations as described herein (e.g., operations associated with performance monitoring of a beam management model). The processors 904 may also include interface circuitry 904D to communicatively couple the processor circuitry with one or more other components of the network device 900.

The CN interface circuitry 914 may provide connectivity to a core network, for example, a 5th Generation Core network (5GC) using a 5GC-compatible network interface protocol such as carrier Ethernet protocols, or some other suitable protocol. Network connectivity may be provided to/from the network device 900 via a fiber optic or wireless backhaul. The CN interface circuitry 914 may include one or more dedicated processors or FPGAs to communicate using one or more of the aforementioned protocols. In some implementations, the CN interface circuitry 914 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

The following sections provide further exemplary embodiments are provided.

Example 1 includes a method comprising: obtaining a set of predicted ranked beams from a beam prediction model; generating a set of measured ranked beams based on respective beam measurements; determining a performance metric associated with the beam prediction model based on respective rankings of the set of predicted ranked beams and the set of measured ranked beams; and generating, for transmission to a network, a report that indicates the performance metric.

Example 2 includes the method of example 1, wherein the performance metric is weighted toward beams of the set or predicted ranked beams or the set of measured ranked beams with higher rankings.

Example 3 includes the method of example 2, further comprising receiving configuration information to indicate a weighting factor for the performance metric.

Example 4 includes the method of example 1, further comprising receiving configuration information to indicate a number of beams to be included in a subset of predicted ranked beams, wherein the performance metric is based on the subset of predicted ranked beams that have a highest ranking among the set of predicted ranked beams.

Example 5 includes the method of example 1, wherein the performance metric is determined based further on measurement values associated with respective predicted ranked beams of the set of predicted ranked beams.

Example 6 includes the method of example 1, wherein the performance metric includes a Spearman correlation.

Example 7 includes the method of example 1, wherein the performance metric includes a Kendall correlation.

Example 8 includes the method of example 1, wherein the performance metric includes a normalized discounted cumulative gain (nDCG).

Example 9 includes the method of example 1, wherein the performance metric includes a rank-biased overlap (RBO).

Example 10 includes a method comprising: receiving, from a user equipment (UE), a performance metric associated with a beam prediction model, wherein the performance metric is based on respective rankings of a set of predicted ranked beams and a set of measured ranked beams; determining an action based on the performance metric; and generating, for transmission to the UE, an indication of the action.

Example 11 includes the method of example 10, further comprising generating, for transmission to the UE, configuration information to indicate a weighting factor for the performance metric, wherein the performance metric is weighted toward beams of the set or predicted ranked beams or the set of measured ranked beams with higher rankings based on the weighting factor.

Example 12 includes the method of example 10, further comprising generating, for transmission to the UE, configuration information to indicate a number of beams to be included in a subset of predicted ranked beams, wherein the performance metric is based on the subset of predicted ranked beams that have a highest ranking among the set of predicted ranked beams.

Example 13 includes the method of example 10, wherein the performance metric includes a Spearman correlation.

Example 14 includes the method of example 10, wherein the performance metric includes a Kendall correlation.

Example 15 includes the method of example 10, wherein the performance metric includes a normalized discounted cumulative gain (nDCG).

Example 16 includes the method of example 10, wherein the performance metric includes a rank-biased overlap (RBO).

Example 17 includes processing circuitry to: process configuration information that indicates monitoring resources; obtain a set of predicted ranked beams from a beam prediction model; obtain a set of measured ranked beams based on beam measurements on the respective monitoring resources; determine a performance metric associated with the beam prediction model based on respective rankings of the set of predicted ranked beams and the set of measured ranked beams; and generate, for transmission to a network, a report that indicates the performance metric.

Example 18 includes the processing circuitry of example 17, wherein the configuration information includes a weighting factor for the performance metric, wherein the performance metric is weighted toward beams of the set or predicted ranked beams or the set of measured ranked beams with higher rankings based on the weighting factor.

Example 19 includes the processing circuitry of example 17, wherein the configuration information indicates a number of beams to be included in a subset of predicted ranked beams, wherein the performance metric is based on the subset of predicted ranked beams that have a highest ranking among the set of predicted ranked beams.

Example 20 includes the processing circuitry of example 17, wherein the performance metric includes a Spearman correlation, a Kendall correlation, a normalized discounted cumulative gain (nDCG), or a rank-biased overlap (RBO).

Another example may include an apparatus comprising means to perform one or more elements of a method described in or related to any of examples 1-20, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example may include a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
obtaining a set of predicted ranked beams from a beam prediction model;
generating a set of measured ranked beams based on respective beam measurements;
determining a performance metric associated with the beam prediction model based on respective rankings of the set of predicted ranked beams and the set of measured ranked beams; and
generating, for transmission to a network, a report that indicates the performance metric.

2. The method of claim 1, wherein the performance metric is weighted toward beams of the set or predicted ranked beams or the set of measured ranked beams with higher rankings.

3. The method of claim 2, further comprising receiving configuration information to indicate a weighting factor for the performance metric.

4. The method of claim 1, further comprising receiving configuration information to indicate a number of beams to be included in a subset of predicted ranked beams, wherein the performance metric is based on the subset of predicted ranked beams that have a highest ranking among the set of predicted ranked beams.

5. The method of claim 1, wherein the performance metric is determined based further on measurement values associated with respective predicted ranked beams of the set of predicted ranked beams.

6. The method of claim 1, wherein the performance metric includes a Spearman correlation.

7. The method of claim 1, wherein the performance metric includes a Kendall correlation.

8. The method of claim 1, wherein the performance metric includes a normalized discounted cumulative gain (nDCG).

9. The method of claim 1, wherein the performance metric includes a rank-biased overlap (RBO).

10. A method comprising:
receiving, from a user equipment (UE), a performance metric associated with a beam prediction model, wherein the performance metric is based on respective rankings of a set of predicted ranked beams and a set of measured ranked beams;
determining an action based on the performance metric; and
generating, for transmission to the UE, an indication of the action.

11. The method of claim 10, further comprising generating, for transmission to the UE, configuration information to indicate a weighting factor for the performance metric, wherein the performance metric is weighted toward beams of the set or predicted ranked beams or the set of measured ranked beams with higher rankings based on the weighting factor.

12. The method of claim 10, further comprising generating, for transmission to the UE, configuration information to indicate a number of beams to be included in a subset of predicted ranked beams, wherein the performance metric is based on the subset of predicted ranked beams that have a highest ranking among the set of predicted ranked beams.

13. The method of claim 10, wherein the performance metric includes a Spearman correlation.

14. The method of claim 10, wherein the performance metric includes a Kendall correlation.

15. The method of claim 10, wherein the performance metric includes a normalized discounted cumulative gain (nDCG).

16. The method of claim 10, wherein the performance metric includes a rank-biased overlap (RBO).

17. An apparatus comprising:
processing circuitry to:
process configuration information that indicates monitoring resources;
obtain a set of predicted ranked beams from a beam prediction model;
obtain a set of measured ranked beams based on beam measurements on the respective monitoring resources;
determine a performance metric associated with the beam prediction model based on respective rankings of the set of predicted ranked beams and the set of measured ranked beams; and
generate, for transmission to a network, a report that indicates the performance metric; and
interface circuitry coupled to the processing circuitry to enable communication.

18. The apparatus of claim 17, wherein the configuration information includes a weighting factor for the performance metric, wherein the performance metric is weighted toward beams of the set or predicted ranked beams or the set of measured ranked beams with higher rankings based on the weighting factor.

19. The apparatus of claim 17, wherein the configuration information indicates a number of beams to be included in a subset of predicted ranked beams, wherein the performance metric is based on the subset of predicted ranked beams that have a highest ranking among the set of predicted ranked beams.

20. The apparatus of claim 17, wherein the performance metric includes a Spearman correlation, a Kendall correlation, a normalized discounted cumulative gain (nDCG), or a rank-biased overlap (RBO).
